(19) United States
(12) Patent Application Publication
(10) Pub. No.: US 2026/0259909 A1
(43) Pub. Date: Sep. 3, 2026

(54) STRUCTURE-BASED DOCUMENT SEGMENTATION FOR EFFICIENT RETRIEVAL-AUGMENTED AI PROCESSING

(71) Applicant: NVIDIA Corporation, Santa Clara, CA (US)

(72) Inventors: Ram Rangan, Adyar (IN); Vladimir Getselevich, Los Gatos, CA (US); Deep Shekhar, Bangalore (IN); Anjul Patney, Kirkland, WA (US)

(21) Appl. No.: 19/067,671

(22) Filed: Feb. 28, 2025

(51) Int. Cl. G06F 16/334; G06F 16/383; G06F 40/169

(52) U.S. Cl. CPC G06F 16/334; G06F 16/383; G06F 40/169

(57) ABSTRACT

Disclosed are apparatuses, systems, and techniques for efficient retrieval-augmented generation (RAG) processing that uses flexible content-based document segmentation. The techniques include obtaining, using a processing device, content metadata representative of a distribution of content of a document and segmenting, using the content metadata, the document into a plurality of segments, at least two segments of the plurality of segments having different size. The techniques further include processing, using an embedding model, the plurality of segments to generate a plurality of embeddings and storing the plurality of embeddings in a data store.

### TECHNICAL FIELD

At least one embodiment pertains to facilitating efficient processing of data using artificial intelligence (AI) systems. For example, at least one embodiment pertains to augmentation of AI processing with stored vectors representative of content of documents and other data relevant for AI operations.

### BACKGROUND

Language models (LMs), including large language models (LLMs), small language models (SLMs), vision language models (VLMs), multi-modal language models (MMLMs), etc., are machine learning models capable of supporting conversations in natural language, understanding speaker intent and emotions, explaining complex topics, generating new texts/images/audio/etc., upon receiving suitable prompts, as well as providing recommendations regarding topics of interest to a user, processing images, audios, and/or other data types, and/or performing other functions. LMs typically undergo self-supervised training on massive amounts of text data and/or other data types, depending on the embodiment, and learn to predict next and/or missing tokens (which may correspond to sub-words, symbols, words, etc.) in a phrase/sentence, detect intent and/or sentiment of a human speaker, determine if two sentences are related or unrelated, and/or perform other basic language tasks. Following the initial training, LMs often undergo instructional (prompt-based) supervised fine-tuning that causes LMs to acquire more in-depth language proficiency and/or master more specialized tasks. Supervised fine-tuning includes using learning prompts (questions, hints, etc.) that are accompanied by example texts (e.g., answers, sample essays, etc.) serving as training ground truth. In reinforcement fine-tuning, a human evaluator assigns grades indicative of a degree to which the generated text resembles human-produced texts. VLMs, including MMLMs, combine the ability to express perceived objects in texts with visual perception, e.g., to perform image captioning and/or other tasks.

### BRIEF DESCRIPTION OF DRA WINGS

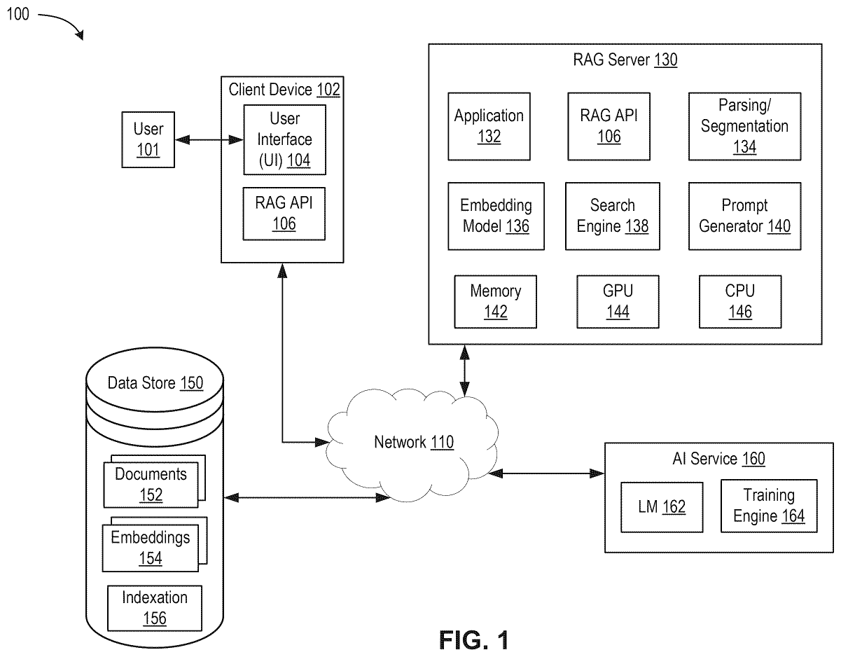

FIG. 1 is a block diagram of an example computing architecture capable of implementing flexible content-based document segmentation for efficient RAG databases, according to at least one embodiment;

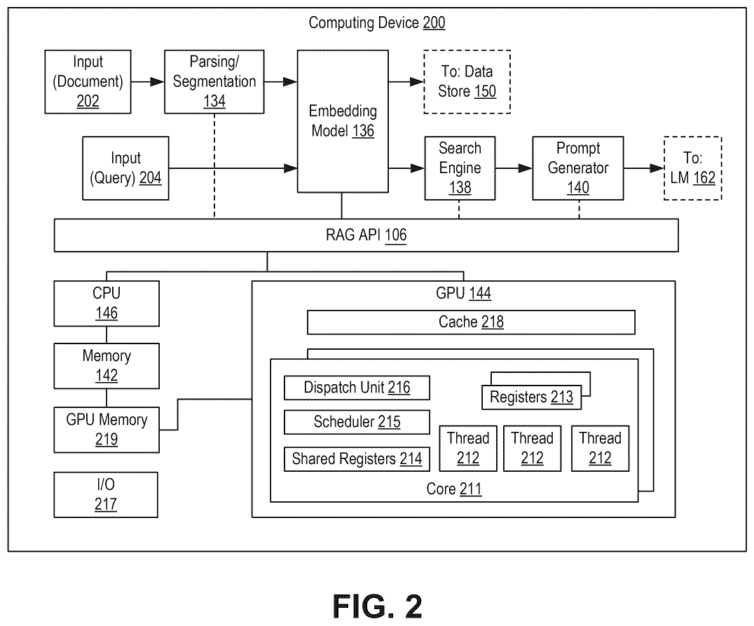

FIG. 2 illustrates an example computing device that supports flexible content-based document segmentation for efficient RAG processing. In at least one embodiment, according to at least one embodiment;

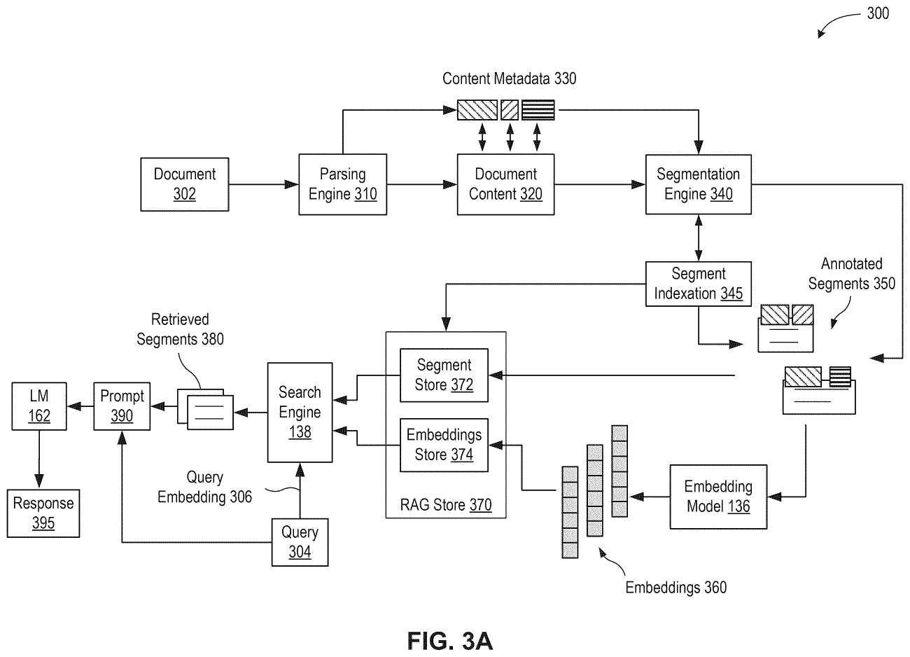

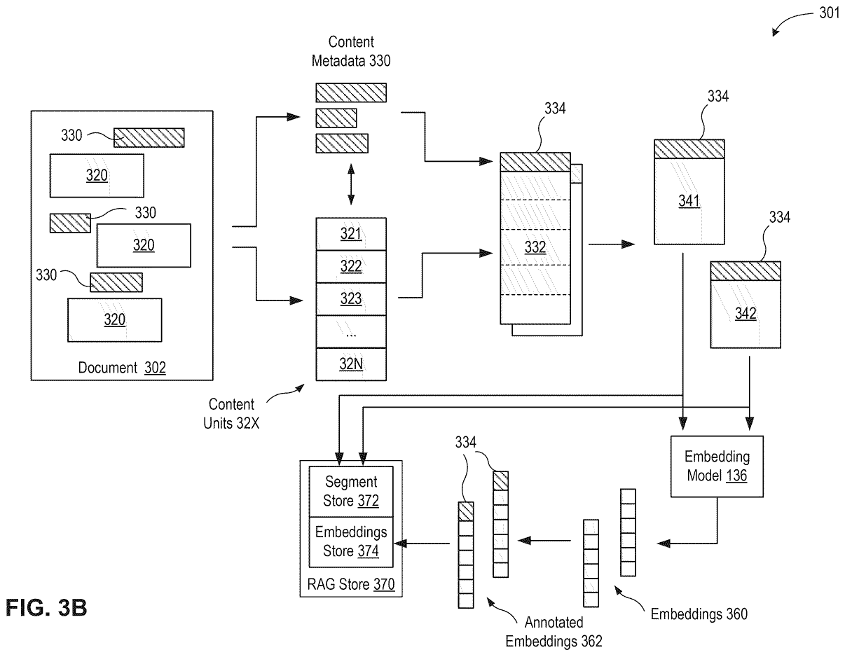

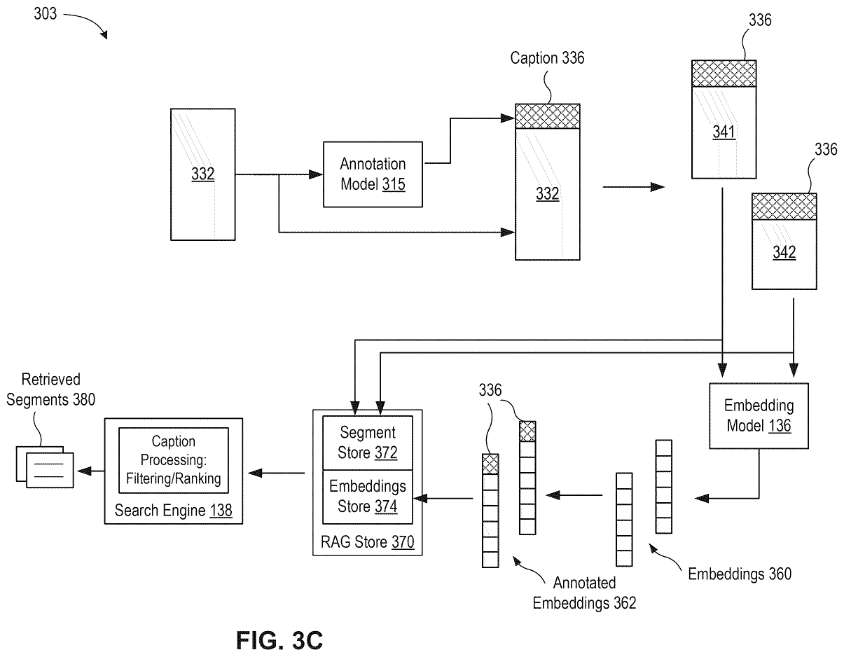

FIG. 3A illustrates an example data flow of efficient RAG processing that uses flexible content-based document segmentation, according to at least one embodiment;

FIG. 3B illustrates example operations of parsing and segmentation performed as part of efficient RAG processing of FIG. 3A, according to at least one embodiment;

FIG. 3C illustrates example operations of language model captioning to assist in flexible content-based document segmentation of efficient RAG processing, according to at least one embodiment;

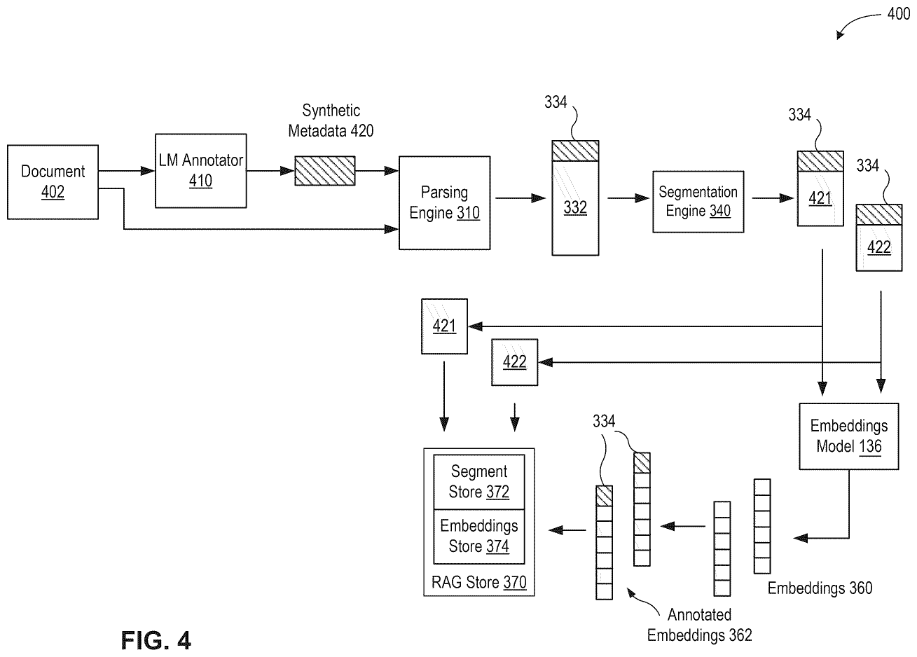

FIG. 4 illustrates an example data flow of efficient RAG processing that uses flexible content-based segmentation of documents lacking content metadata;

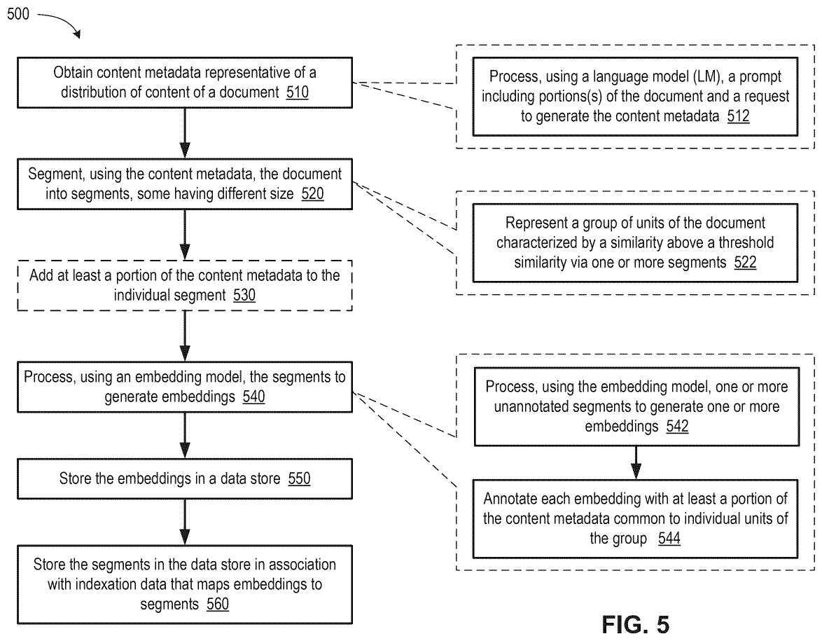

FIG. 5 is a flow diagram of an example method of an indexing stage of efficient RAG processing that uses flexible content-based document segmentation, according to at least one embodiment;

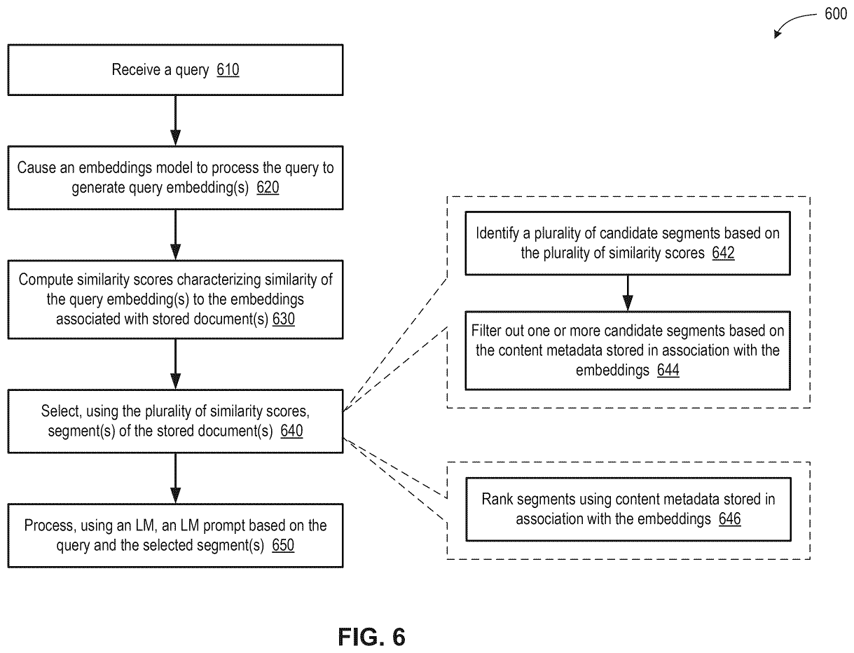

FIG. 6 is a flow diagram of an example method of a query processing stage of efficient RAG processing that uses flexible content-based document segmentation, according to at least one embodiment;

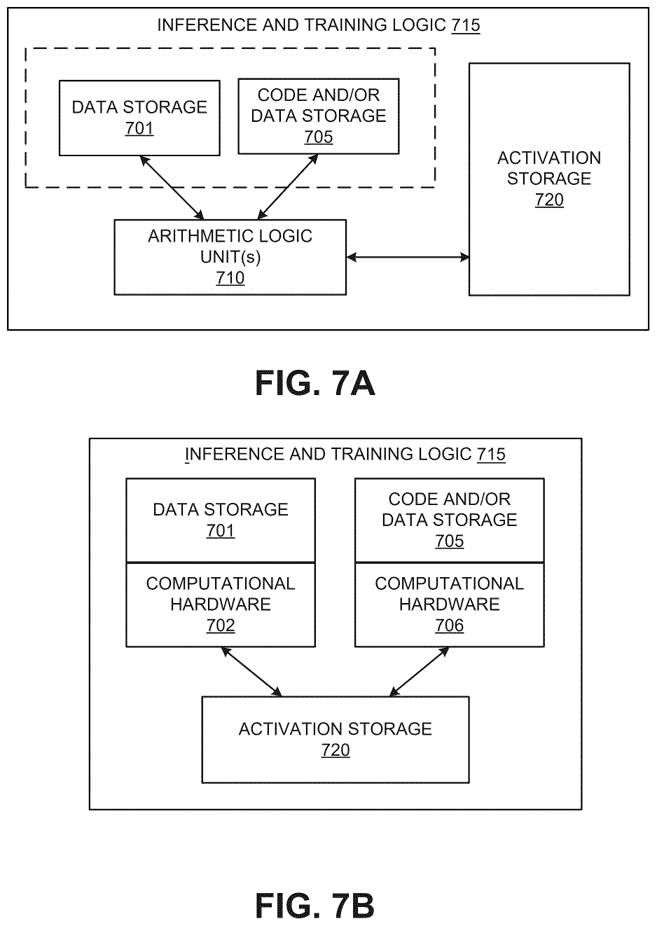

FIG. 7A illustrates inference and/or training logic, according to at least one embodiment;

FIG. 7B illustrates inference and/or training logic, according to at least one embodiment;

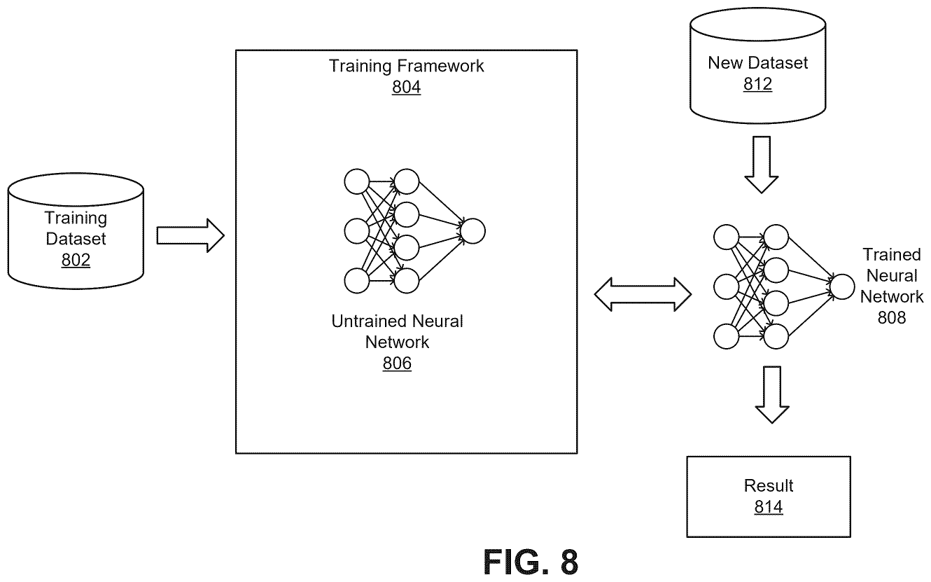

FIG. 8 illustrates training and deployment of a neural network, according to at least one embodiment;

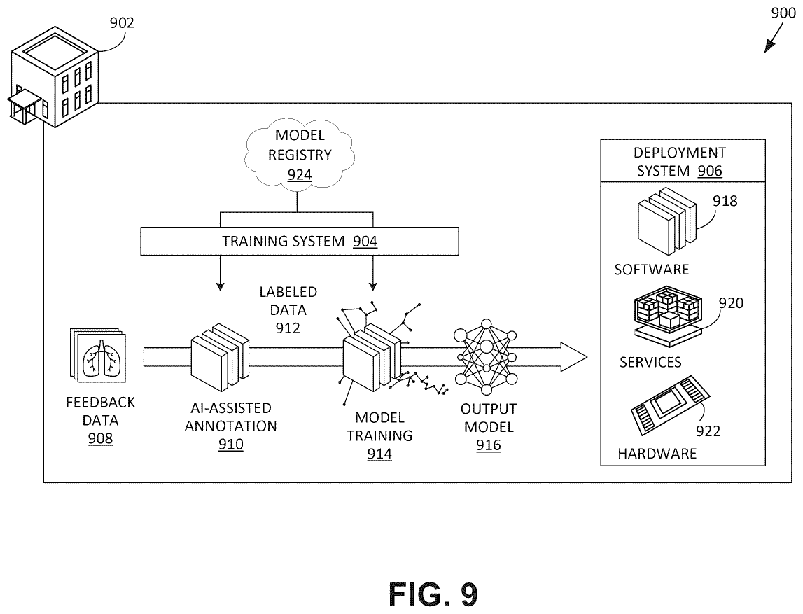

FIG. 9 is an example data flow diagram for an advanced computing pipeline, according to at least one embodiment;

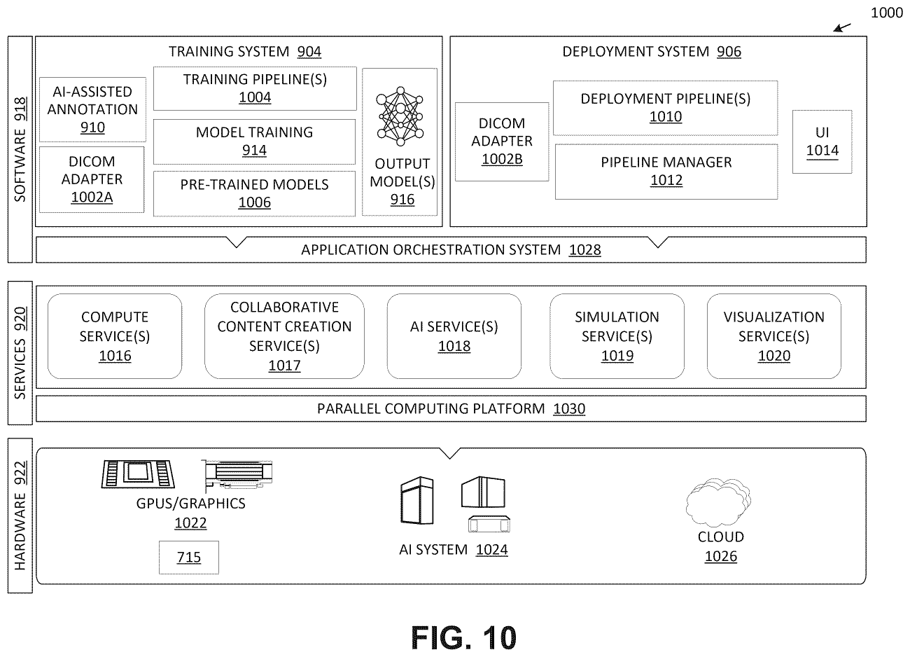

FIG. 10 is a system diagram for an example system for training, adapting, instantiating and deploying machine learning models in an advanced computing pipeline, according to at least one embodiment;

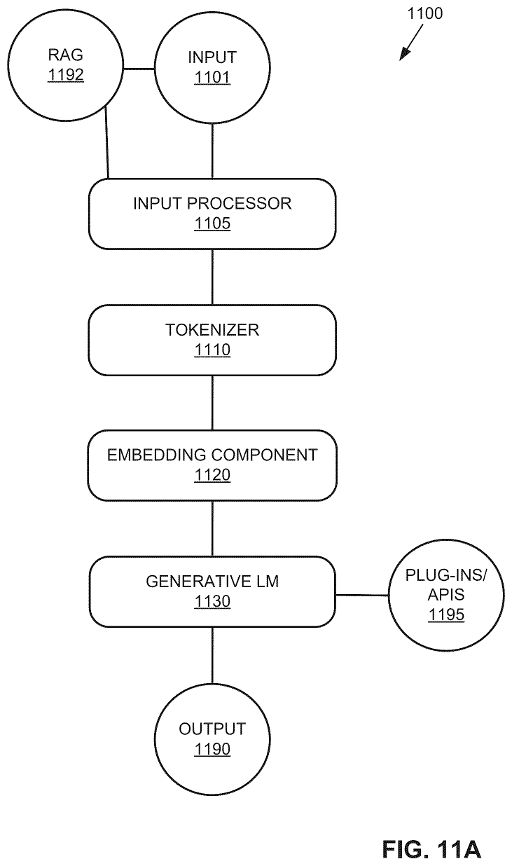

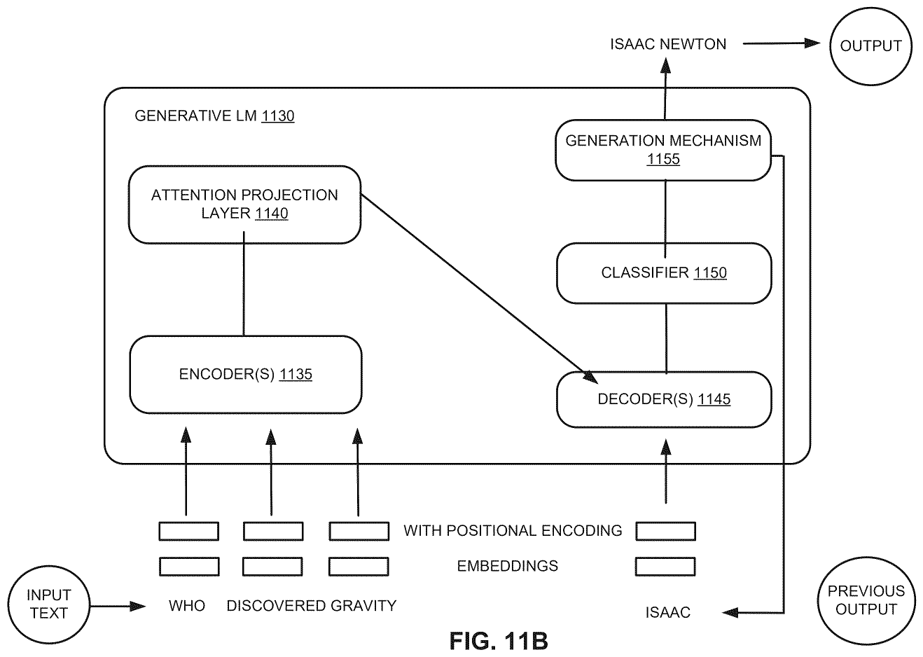

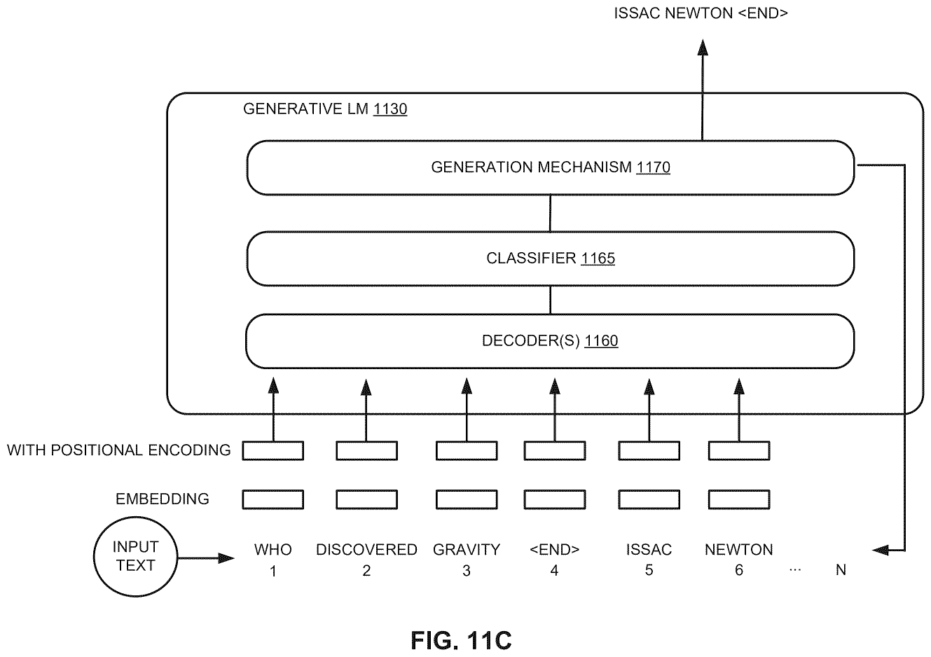

FIG. 11A is a block diagram of an example generative language model system suitable for use in implementing at least some embodiments of the present disclosure;

FIG. 11B is a block diagram of an example generative language model that includes a transformer encoder-decoder suitable for use in implementing at least some embodiments of the present disclosure;

FIG. 11C is a block diagram of an example generative language model that includes a decoder-only transformer architecture suitable for use in implementing at least some embodiments of the present disclosure;

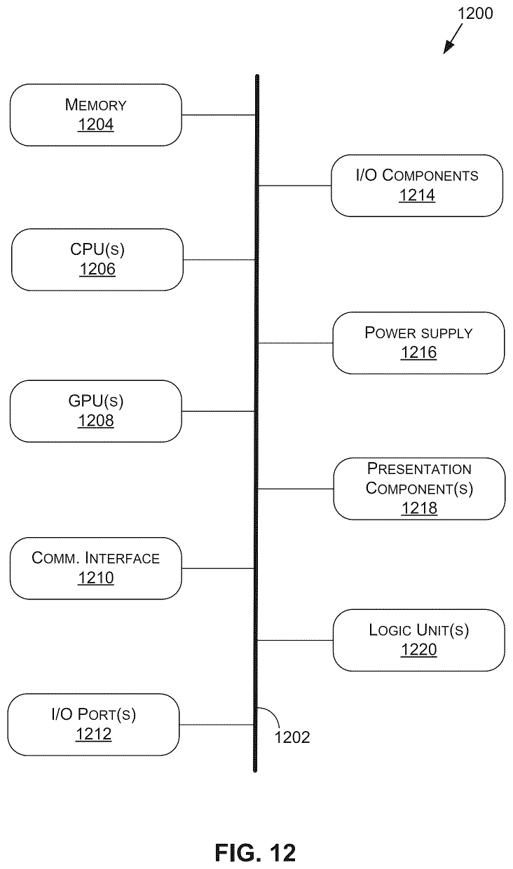

FIG. 12 is a block diagram of an example computing device suitable for use in implementing some embodiments of the present disclosure; and

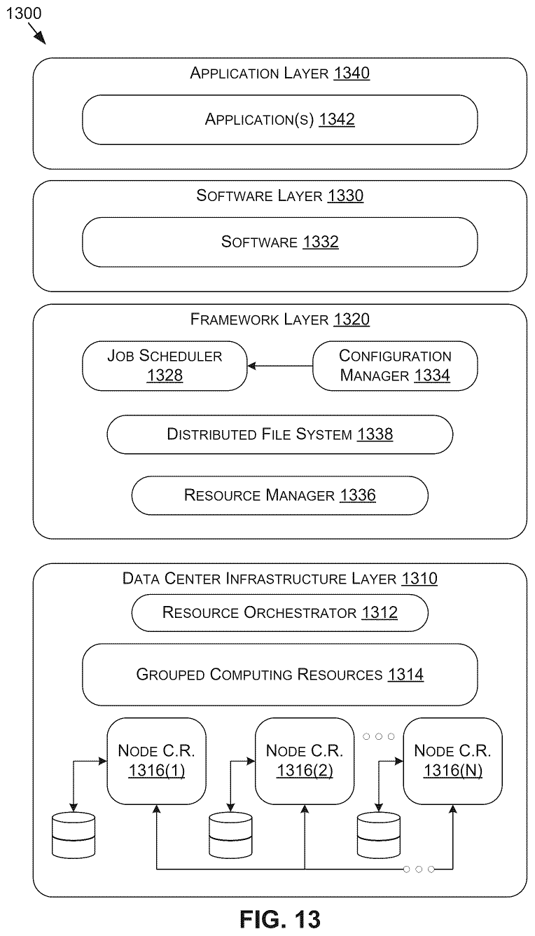

FIG. 13 is a block diagram of an example data center suitable for use in implementing some embodiments of the present disclosure.

### DETAILED DESCRIPTION

Training of language models (LMs), including large language models (LLM) and/or vision language models (VLMs), typically involves large volumes of training data (e.g., human-created texts) and teaches LMs to generate responses to user queries that include questions, requests for information, advice, explanations of various general and specialized subjects, images, videos, audios, digital assets, and/or the like. Since the number of topics that can be of interest to users is practically unlimited, LMs are regularly tasked with responding to queries about things and concepts that have not been extensively represented in the training data. Such queries can lead to suboptimal responses that can be incorrect and/or misleading.

Retrieval-augmented generation (RAG) is the technique that improves outputs of the LMs by augmenting LM inputs (queries) with additional information that may be of relevance to the inputs, e.g., information that includes context, data, specialized knowledge about the subject of the query, and so on. Such additional information may be stored in the form of embeddings—feature vectors or vectors in a special N-dimensional embedding space—that encode words, sub-words, characters, images or portions of images, videos or portions of videos, and/or the like together with their contextual or semantic connections. A trained encoder may encode strings of text into embeddings, which may be considered as points in the embedding space. During training, the encoder learns to associate similar strings of text with similar embeddings corresponding to points closely situated in the embedding space and further learns to associate dissimilar strings of text with points that are located farther apart in the embedding space. A contextual information relevant to a particular LM query may be presented in the form of such embeddings, which may be pre-generated, for faster retrieval, and stored in a suitable data store.

To take advantage of the RAG techniques, a received LM query may similarly be converted into one or more embeddings, depending on the size of the query. These query embeddings may then be compared to embeddings stored in the data store. For example, similarity factors (e.g., scalar products) between pairs of embeddings may be computed and a set of stored embeddings most closely related to the query embedding may be identified. Portions of documents corresponding to the identified embeddings may be combined with the user-generated query, as part of the contextual information, to generate a prompt that is then used as an input into the LM, to assist the LM in producing a more relevant and accurate response. In RAG techniques, large documents are represented with multiple embeddings, e.g., with document segments of a fixed size (e.g., 500 words/tokens, 1000 words/tokens, etc.) represented via individual embeddings. Such fixed-size segments, however, can result in sub-optimal query augmentation. More specifically, segments obtained without regard to their actual content can include unrelated information from different paragraphs or even sections of a document which can be confusing to an LM when included in the prompt. Furthermore, related relevant content can be split between different segments. Depending on what type of additional information is included in such segments, a retrieval function can identify some segment(s) of the content while missing other segments(s), whose similarity to a query can be obscured by the presence of unrelated information in such segments.

Consequently, fixed-size segmentation, which fails to account for the content of segments, does not take full advantage of RAG capabilities and can even lead to LM hallucinations and other undesired effects. Additionally, fixed-size segmentation can make important document metadata or annotations (stated only once, e.g., near the top of the document) included in the first segment but leave other segments unannotated causing the retrieval function to miss those segments.

Aspects and embodiments of the present disclosure address these and other challenges of RAG technology by providing for systems and techniques of flexible, semantic structure-preserving, content-based document segmentation into variable-length segments that facilitate building efficient RAG databases. In some embodiments, a document may have intrinsic structure, e.g., partitioned into chapters, sections, subsections, tables, and/or other structural elements that are tagged using any suitable identifiers, fields, annotations, captions, or delimiters, referred to as content metadata herein. For example, an HTML document may have fields or tags that identify a document title, section headings, subsection (sub-subsection, etc.) headings, table elements, paragraphs, emphasized language (e.g., boldfaced and/or italicized language), and/or the like. A parsing engine may process such a document, harvest the document's content metadata, and generate annotations representative of the distribution of content of the document. For example, annotations may indicate, for sufficiently small portions or units of the document (which may be smaller than a typical size of the eventual segments), association of those units with topics, headers, sub-headers, tables, quotations, emphasized language, and/or other elements. Units may be defined as small fixed-size portions (e.g., 50 words/tokens, 100 words/tokens, etc.) of the document or portions that have natural boundaries, e.g., paragraphs with defined paragraph breaks, small sections, tables and/or table partitions, and/or other well-formed elements of the document. The generated annotations may be stored as a metadata file (annotations) for the document. Subsequently, a segmentation engine may apportion the document into segments that include units with sufficiently common or related annotations. In one non-limiting example, two units of a document may receive a similarity score that is based on similarity or differences in the annotations of the two units. For example, if the units have matching topics or are associated with the same section of the document, a certain similarity score S₁ may be assigned to the units. If the units also belong to the same subsection, an additional similarity score S₂ may be assigned. Likewise, further similarity scores S₃, S₄, etc. may be assigned for including elements of the same table, for having common keywords, and/or the like.

Various similarity scores may be aggregated (e.g., added) into a total similarity score Sₜₒₜ that may be used to determine if any two units have similar content. For example, the total similarity score Sₜₒₜ exceeding a certain (empirically) set threshold S_{T} may indicate that the units are sufficiently related to be included (if practically possible) together into the same segment. Conversely, the total similarity score Sₜₒₜ being less than the threshold S_{T} indicates that the units are sufficiently distinct to be placed in different segments. Accordingly, a segmentation engine may group units into segments based on the similarity scores of the units. For example, a sequence of units may be included in the same segment if similarities of pairs of neighboring units in the segment are above S_{T}. In some embodiments, a sequence of units may be included in the segment if multiple (or all) pairwise similarities of the candidate units in the segment are above S_{T}, Correspondingly, segments of variable size may be formed that have a common context.

In some instances, the segmentation engine may define a maximum size L₀ of a segment, so that when a group of units with high similarity has the total size that exceeds L₀, the group is split into multiple segments. In some embodiments, a new segment may be started for such a group independently of the size of the previous segment. In some embodiments, one or more units of the group may be added to the previous segment. In such embodiments, joining of units into segments may be optimized to reduce the number of segment breaks (boundaries). For example, if the total length of a group is L=1.6L₀ while available space of length 0.4L₀ is available in the last segment n, the segmentation engine may start new segments n+1 and n+2 and allocate the first 1.0L₀ of the units of the group to segment n+1 and the last 0.6L₀ units into segment n+2 (or equal amounts of 0.8L₀ to both segments) instead of allocating the first 0.4L₀ of the units to segment n, the next 1.0L₀ of the units to segment n+1, and the last 0.2L₀ of the units to segment n+2). On the other hand, if space of length 0.6L₀ is available in segment n, the segmentation engine may allocate the first 0.6L₀ of the units of the group to segment n and the last 1.0L₀ units into segment n+1. Various units from the same contextual group spread over multiple segments may share the same annotation information to more closely align their embeddings and increase the likelihood that such multiple segments are retrieved together.

In some embodiments, segments with added annotations are converted to embeddings. In some embodiments, segments without annotations are first converted to embeddings with the annotations then added as metadata to the embeddings. In some embodiments, a hybrid approach may be used where some (or all) annotations are embedded with the content units and other (or same, or even all) annotations are added as metadata to the embeddings. In other embodiments, content units (or groups of content units) having a common context can be used as part of a prompt into an LM requesting the LM to generate a short description (e.g., summary) of the content units that is then used as a caption for these content units. Such captions may be used during the retrieval process in a variety of ways. In particular, a caption may be used for filtering RAG retrievals that are of no or low relevance to the queries. For example, a natural language processing (NLP) component may evaluate linguistic or semantic similarity of the retrieved segments of documents and discard those segments that have little or no similarity to the query. In other embodiments, the retrieved segments may be ranked in the order of similarity to the query with the rankings determined via a combination of the embedding similarity (e.g., cosine similarity) between embeddings of the query and embeddings of the segments and the linguistic/semantic similarity between the segment captions and the query (the two types of similarity may be suitably weighted with empirically set weights). A certain (predetermined) number of segments with the highest combined similarity or all segments with at least a minimum similarity may be included with the query to form the prompt.

In some instances, a document may lack content metadata, e.g., may be a plain text document with no explicitly identified headings, topics, tables, and/or similar content distribution information. Such a document may be used as an input into an LM (which may the same LM that is used to process user queries/prompts or a different LM) together with a prompt requesting the LM to add synthetic content annotations to the document, e.g., HTML or other suitable annotations. Documents with synthetic content annotations may then be parsed and segmented in the same (or substantially similar) way as described above. In some embodiments, the synthetic metadata may be added to stored document segments (which are provided, upon retrieval, as part of the prompt). In other embodiments, to reduce potential consequences of LM hallucinations that may be present in the generated synthetic metadata, such synthetic metadata may be added to the document as part of embedding generation but not added to the stored raw document segments.

In some embodiments, a document lacking annotation can be processed by a VLM or a MMLM that identifies structure (distribution of content) of the document based on an image of the document (or a combination of the image of the document and text content of the document). The VLM (or MMLM) may identify sections/headings, topics, tables partitions, figures, emphasized language, and/or other similar information representative of the content distribution in the document. In some embodiments, a VLM (or MMLM) may also identify locations of special objects, e.g., images, plots, graphics, etc., in the document and generate separate embeddings representative of such cropped special objects.

The advantages of the disclosed embodiments include (but are not limited to) creation of content-aware RAG databases that group related content into the same or connected segments. This facilitates retrieval of documents that are relevant for query processing while significantly reducing false positive retrievals that burden LMs with irrelevant or unrelated information that is likely to result in incorrect responses or even hallucinations. As a result, accuracy and relevance of LM responses is improved together with users' satisfaction as the need for follow-up questions and clarifications is significantly reduced.

FIG. 1 is a block diagram of an example computing architecture 100 capable of implementing flexible content-based document segmentation for efficient RAG databases, according to at least one embodiment. As depicted in FIG. 1, computer architecture 100 may include a client device 102, a RAG server 130, a data store 150, and an AI service 160 connected via a network 110. Network 110 may be a public network (e.g., the Internet), a private network (e.g., a local area network (LAN), or wide area network (WAN)), a wireless network, a personal area network (PAN), a combination thereof, and/or another network type.

AI service 160 may support and train one or more AI models, including but not limited to LM 162. It should be understood that services associated with various other AI models that use RAG technology may similarly be improved with the disclosed techniques, e.g., vision language models (VLMs), multi-modal LMs (MMLMs), automatic speech recognition (ASR) models, computer vision (CV) models, text-to-speech models, anomaly detection models, action detection models, object detection models, and/or any other suitable generative or discriminative AI models.

In some embodiments, LM 162 and/or various facilities of RAG server 130 may be provided to user 101 via client device 102, which may be (or include) one or more computing devices that are under control of user 101, e.g., a desktop computer, a laptop computer, a smartphone, a tablet computer, a server, a wearable device, a virtual/augmented/mixed reality headset or head-up display, a digital avatar or chatbot kiosk, an in-vehicle infotainment computing device, and/or any suitable computing device capable of performing the techniques described herein. User 101 may be a person (e.g., an individual user) or an organization (e.g., a collective user). Client device 102 may include a memory and one or more processors (not shown in FIG. 1 for conciseness) communicatively coupled to the memory to support local computations performed on client device 102.

In some embodiments, client device 102 may support a user interface (UI) 104 to receive documents (or other data) and user queries (or other inputs of AI models) from user 101 and communicate to user 101 responses to user queries (or any other outputs of LM 162 or other AI models). UI 104 may include one or more devices of various modalities, e.g., a keyboard, a touchscreen, a touchpad, a writing pad, a graphical interface, a mouse, a stylus, and/or any other pointing device capable of selecting words/phrases that are displayed on a screen, and/or some other suitable device. In some embodiments, UI 104 may include an audio device, e.g., a combination of a microphone and a speaker, a video device, such as a digital camera to capture an image or a sequence of two or more images (video frames). In some embodiments, text, speech, and/or video input devices may be integrated together, e.g., as part of a smartphone, tablet computer, desktop computer, and/or the like.

Client device 102 may implement access of user 101 to RAG server 130 and/or AI service 160. RAG server 130 and/or AI service 160 may support cloud-based computation, storage of data, authentication of data, and/or any other services that may be provided to user 101 as part of paid or free subscription. Processing and storage of data on RAG server 130 and/or AI service 160 may be protected using any suitable cryptographic protection techniques, including but not limited to symmetric and asymmetric key cryptography, digital authentication, and/or the like.

RAG server 130 may deploy one or multiple computing devices, which may include a memory 142 (e.g., one or more memory devices or units) communicatively coupled to one or more processing devices, such as one or more graphics processing units (GPU) 144, one or more central processing units (CPU) 146, one or more data processing units (DPU), one or more parallel processing units (PPUs), and/or other processing devices (e.g., field-programmable gate arrays (FPGAs), application-specific integrated circuits (ASICs), and/or the like). Memory 142 may include a read-only memory (ROM), a flash memory, a dynamic random-access memory (DRAM), such as synchronous DRAM (SDRAM), a static memory, such as static random-access memory (SRAM), and/or some other memory capable of storing digital data. RAG server 130 may support execution of an application 132, which may be a text processing application, a video processing application, an audio processing application, a gaming application, an image or video rendering application, a computational application, a data processing application, a browsing application, and/or any other suitable application. Application 132 may be remotely provided to user 101 via UI 104 and client device 102.

RAG server 130 may deploy one or more processing devices (not shown in FIG. 1) and may operate to augment AI service 160. In some embodiments, RAG server 130 may be operated as part of AI service 160 (e.g., under control of the same entity). In some embodiments, RAG server 130 may be operated independently of AI service 160 but may support inference operations of clients (such as user 101) using AI service 160.

In some embodiments, AI service 160 may deploy LM 162, which may be an LLM, SLM, VLM or some other MMLM. LM 162 may have any number of learned parameters, e.g., one million or more learned parameters. In some instances, LM 162 may have over a billion of learned parameters. LM 162 may be trained by training engine 164. In some embodiments, LM 162 may be trained in multiple stages. Initially, training engine 164 may train LM 162 to capture syntax and semantics of human language, e.g., by training to predict the next, the previous, and/or a missing word in a sequence of words (e.g., one or more sentences of a human speech or text). LM 162 may be further trained using training data containing a large number of texts, such as human dialogues, newspaper texts, magazine texts, book texts, web-based texts, and/or any other texts. Since ground truth for such training is embedded in the texts themselves, training engine 164 may use such texts for self-supervised training of LM 162. This teaches LM 162 how to carry out a conversation with a user (a human user or computer chatbot) in a natural language in a manner that closely resembles a dialogue with a human speaker, including understanding the user's intent and responding in ways that the user expects from a conversational partner. Following the initial self-supervised training, training engine 164 may implement a supervised fine-tuning of LM 162 to teach LM 162 more specialized language skills, including expertise in a particular field of knowledge.

LM 162 may be implemented using neural networks with a large number (e.g., millions or billions) of artificial neurons with an individual neuron receiving its input from other neurons and/or from an external source and producing an output by applying an activation function to the sum of weighted (using trainable weights) inputs and, possibly, a bias value. In at least one embodiment, LM 162 may be implemented as a deep learning neural network having multiple levels of linear and non-linear operations, including an input layer, one or more hidden layers, and/or an output layer. Neurons from adjacent layers may be connected by weighted edges. LM 162 may include convolutional neural networks, recurrent neural networks, fully-connected neural networks, long short-term memory (LSTM) neural networks, neural networks with attention, e.g., transformer neural networks, a combination of a convolutional network and one or more transformers (a conformer), and/or neural networks of other types.

Initially, parameters (e.g., edge weights and biases) of LM 162 may be assigned some starting (e.g., random) values. For various training inputs, training engine 164 may cause LM 162 to generate training output(s). Training engine 164 may then compare training output(s) with the desired target output. The resulting error or mismatch, e.g., the difference between the target output(s) and the training output(s), may be backpropagated through various neural layers of LM 162, and the weights and biases of LM 162 may be adjusted to make the training outputs closer to the target outputs. In some embodiments, training engine 164 may train multiple LMs 162 for multiple tasks, e.g., multiple different fields of knowledge.

In some embodiments, RAG server 130 may deploy a RAG API 106 that provides, to a user, a set of commands that can be understood by a non-expert user and may implement any, some, or all operations of the document indexing stage and/or query processing stage for augmentation of AI processing. In some embodiments, an API package with RAG API 106 may be downloaded to client device 102. The downloaded API package may be used to install RAG API 106 to enable user 101 to deploy augmented AI processing on, via, or using RAG server 130. The commands made available via RAG API 106 may include a high-level ADD (or some other similar command) command to include a document (or any set of documents) in the RAG database during the document indexing stage. For example, user 101 may use the ADD command to identify a document stored on client device 102 or elsewhere (e.g., in data store 150). RAG API 106 may then convert (e.g., using one or more preprogrammed calls), the ADD command into a series of low-level jobs to upload the identified document(s) to RAG server 130, perform operations of parsing/segmentation module 134 for the uploaded documents (e.g., as disclosed in more detail below), and then process various segments of the document(s) using an embedding model 136. Processed, e.g., segmented, documents 152 may be stored in data store 150 together with embeddings 154 associated with the corresponding segmented documents 152.

Similarly, during the query processing stage, user 101 may submit a query using a high-level command AUGMENT (or some other similar command) which instructs RAG API 106 to schedule and execute another set of low-level jobs to generate query embedding(s) and run a search engine 138 to identify stored documents (and segments of documents) that are relevant to the query. The jobs scheduled by RAG API 106 may then operate a prompt generator 140 that augments the query with the identified documents/segments to form an input into an AI model, e.g., a prompt to LM 162. In some embodiments, prompt generator 140 may use indexation 156 of embeddings 154 to corresponding portions of documents 152 that such embeddings represent.

In some embodiments, RAG API 106 downloaded from RAG server 130 to client device 102 may execute any, some, or all of parsing/segmentation module 134, embedding model 136, search engine 138, and/or prompt generator 140 locally on client device and communicate prompts to (and receive generated response from) AI service 160 directly without the use of RAG server 130. In some embodiments, any, some, or all operations of RAG server 130 and/or client device 102 may be implemented in a secure container. More specifically, various codes implementing any, some, or all of RAG API 106, any, some, or all of parsing/segmentation module 134, embedding model 136, search engine 138, and/or prompt generator 140 may be packaged into an image container, e.g., a lightweight executable software package that may be instantiated on RAG server 130 and/or client device 102. The image container may further include various system tools, libraries, and settings.

Documents 152, embeddings 154, indexation 156, and/or other data stored in data store 150 may be accessible to RAG server 130, client device 102, and/or other computing devices not explicitly shown in FIG. 1 via a bus, interconnect, and/or the like, or via network 110. Data store 150 may include persistent storage and may be hosted by one or more storage devices, such as main memory, magnetic or optical storage disks, tapes, or hard drives, network-attached storage (NAS), storage area network (SAN), and so forth. Although depicted as separate from RAG server 130 and/or client device 102, in at least some embodiments, data store 150 may be a part of RAG server 130, and/or client device 102. In at least some embodiments, data store 150 may be a network-attached file server, while in other embodiments, data store 150 may be some other type of persistent storage, such as an object-oriented database, a relational database, and so forth, that may be hosted by RAG server 130 and/or client device 102 or one or more different machines coupled to RAG server 130 and/or client device 102.

FIG. 2 illustrates an example computing device 200 that supports flexible content-based document segmentation for efficient RAG processing, according to at least one embodiment. In at least one embodiment, computing device 200 may be a part of RAG server 130 and/or of client device 102 (with reference to FIG. 1). In at least one embodiment, RAG API 106 may operate on computing device 200. RAG API 106 may facilitate processing of inputs, which may include one or more documents 202 processed as part of a document indexation stage and/or one or more queries 204 processed as part of the query processing stage. RAG API 106 may operate (e.g., as disclosed in conjunction with FIGS. 3A-3C and/or FIG. 4 below) the parsing/segmentation module 134, embedding model 136, search engine 138, and/or prompt generator 140, and/or other components not explicitly depicted in FIG. 2.

Operations and calls of RAG API 106 and various modules operating in conjunction with RAG API 106, and/or other software/firmware instantiated on computing device 200 may be executed using one or more GPUs 144, one or more CPUs 146, one or more parallel processing units (PPUs) or accelerators, such as a deep learning accelerator, data processing units (DPUs), and/or the like. In at least one embodiment, a GPU 144 includes multiple cores 211. An individual core 211 may be capable of executing multiple threads 212. Individual cores 211 may run multiple threads 212 concurrently (e.g., in parallel). In at least one embodiment, threads 212 may have access to registers 213. Registers 213 may be thread-specific registers with access to a register restricted to a respective thread. Additionally, shared registers 214 may be accessed by one or more (e.g., all) threads of a core 211. In at least one embodiment, individual cores 211 may include a scheduler 215 to distribute computational tasks and processes among different threads 212 of the core. A dispatch unit 216 may implement scheduled tasks on appropriate threads using correct private registers 213 and shared registers 214. Computing device 200 may include input/output component(s) 217 to facilitate exchange of information with one or more users or developers.

In at least one embodiment, GPU 144 may have a (high-speed) cache 218, access to which may be shared by multiple cores 211. Furthermore, computing device 200 may include a GPU memory 219 where GPU 144 may store intermediate and/or final results (outputs) of various computations performed by GPU 144. After completion of a particular task, GPU 144 (or CPU 146) may move the output to (main) memory 142. In at least one embodiment, CPU 146 may execute processes that involve serial computational tasks whereas GPU 144 may execute tasks (such as multiplication of inputs of a neural node by weights and adding biases) that are amenable to parallel processing.

FIG. 3A illustrates an example data flow 300 of efficient RAG processing that uses flexible content-based document segmentation, according to at least one embodiment. Operations illustrated in FIG. 3A may be performed by client device 102, RAG server 130, and/or other suitable computing device. Operations illustrated in FIG. 3A may be performed to process, embed, and index any suitable document 302, including a text document, an image, an audio file, a video file, a data file, and/or the like. (Although, for brevity and conciseness, a single document 302 is referenced throughout the description of FIG. 3A, any batch of multiple documents 302 may be processed similarly, e.g., sequentially or in parallel.) In some embodiments, document 302 may be associated with any general or specific area of knowledge, e.g., medical diagnostics, computing technology, mathematics, computer games, art history, and/or the like. Document 302 may be provided using any suitable means, including uploading by a user (e.g., user 101 in FIG. 1) or under control of the user, automatic data collection, database mining, and/or the like. In some instances, e.g., when document 302 is available as an image, document 302 may first undergo optical character recognition (OCR). Prior to (or as part of) the OCR, document 302 may be denoised, filtered, sharpened, or enhanced using any appropriate preprocessing tools or techniques.

Operations illustrated in FIG. 3A may be performed in the instances of document 302 having metadata representative of a distribution of content of document 302. Such metadata may be integrated into the structure of the document or may be external to (or otherwise associated with) the document. The distribution of content may include any suitable metadata tags or any other indicators of the document structure. In some instances, tags may be associated with chapter titles (or headings), section titles, subsection titles, sub-subsection titles, and/or other elements that define hierarchical or parallel (or some combination thereof) structure of document 302. For example, HTML documents may have multiple levels of headings, e.g., <h1>, <h2>, . . . <h6>, which can be used to mark sections of a document. For example, <h1> Electric fields </h1> may indicate the first (highest) hierarchical heading level (section title), <h2> Static electric fields </h2> may indicate the second hierarchical heading level (subsection title), <h3> Static electric fields in basic materials </h3> may indicate the third hierarchical heading level (sub-subsection title), <h4> Static electric fields in dielectric materials </h4> may indicate the fourth hierarchical heading level, and so on.

The metadata tags indicating the distribution of content of document 302 may further include indicators of tables and table elements, e.g., <table> and </table> to indicate start and end of a table, <figure> and </figure> to indicate a figure, <img> and </img> to indicated an image, <caption> and </caption> to indicate table caption (e.g., <caption> Refractive indices of transparent materials </caption>), <tr> and </tr> to indicate table rows and <td> and </td> to indicate table cells (e.g., <tr> <td> Water </td> <td>1.33</td> <\tr>), table headings (e.g., <thead>). The metadata tags may further indicate highlighted text, e.g., <mark> Total internal reflection angle </mark> or emphasis (<em>), footers, e.g., <footer> The data is for room temperature, T=20 degrees C. </footer> or headers, content containers, e.g., <body>, ordered lists and list items, e.g., <ol> and <li>, figure captions, e.g., <figcaption>, block quotations, e.g., <blockquote>, data lists, e.g., <datalist>, content summary, e.g., (<summary>), delimiters or line breaks, e.g., <br>, and/or the like.

Document 302 may undergo processing by a parsing engine 310 that identifies the distribution of content within document 302 by parsing metadata tags and identifying both document content 320, e.g., a portion of text describing electric properties of water, and the corresponding content metadata 330, e.g., starting and ending locations of the portion, a number of lines/paragraph of the portion, a set of section, subsection, etc., headings (or topics/subtopics/etc.) associated with the portion, emphasized and/or highlighted language in the portion, references to other portions of the same document (or other documents), presence of tables and specific table elements, images, figures, data lists, captions, quotes, footers/headers, and/or any other elements that may be tagged according to a particular metadata format used in document 302. Parsing engine 310 may then use the harvested content metadata 330 to generate annotations to various content units of document 302. Content units sharing the same content may be grouped together (e.g., as disclosed in more detail below in conjunction with FIG. 3B) and segmented, by segmentation engine 340, into annotated segments 350.

Embedding model 136 may process annotated segments 350 to generate embeddings 360. Embeddings 360 may be vectors in an embedding space of a suitable number of dimensions N, which may be determined as part of the architecture of embedding model 136. Embedding model 136 represents individual annotated segments 350 as vectors (or, equivalently, points) in the embedding space. Components of embeddings 360 may have integer value or floating-point values.

Annotated segments 350 may be stored in a segment store 372, which may be implemented as part of a RAG store 370. In some embodiments, annotations may be removed from segments prior to storing in segments store 372. Segmentation engine 340 may also perform segment indexation 345, e.g., by assigning unique identifiers (IDs) to various segments. For example, individual annotated segments 350 may be indexed by an ID of document 302, a value denoting a location of a particular annotated segment 350 in document 302, a storage location in segment store 372, and/or any other relevant information. The generated embeddings 360 may be stored in embeddings store 374, which may be implemented as part of the same RAG store 370 that hosts segment store 372 or as part of a different store. Stored embeddings 360 may also undergo segment indexation to uniquely identify various embeddings 360 and to map stored embeddings 360 to stored annotated segments 350, e.g., such that a given document segment 350 may be used to identify a corresponding embedding 360 encoding the respective portion of document 302. In some embodiments, RAG store 370 may store thousands or millions (or more) of documents 302 related to any single or multiple knowledge areas.

Segments stored in segment store 372 and embeddings stored in embeddings store 374 may be used to facilitate generation of efficient prompts to LM 162 or to augment inputs into some other AI models. For example, similar operations may be performed to generate images that are based on user's instructions—e.g., descriptions of images—with one or more previously stored images (documents 302) to be identified and used to augment the user's instructions.

As illustrated, a query 304, e.g., a text query, an audio query, a video query, and/or the like, may be received (e.g., via RAG API 106, with reference to FIG. 1 and/or FIG. 2). In the instances of a large query 304, query 304 may be segmented into smaller portions. Query 304 (appropriately segmented, if dictated so by the size of the query) may be converted into one or more query embeddings 306, e.g., by the same embedding model 136. The generated query embedding(s) 306 may be received by search engine 138. Search engine 138 may also receive, e.g., from embeddings store 374, stored embeddings 360. Search engine 138 may identify a number of stored embeddings 360 that are most similar to the query embedding(s) 306 (and, therefore, most pertinent to query 304). In one example embodiment, a cosine similarity function may be used by search engine 138, which computes a scalar product (dot product) of query embedding 306 (QE) and various stored embeddings 360 (SEⱼ, with j standing for any suitable ID of the stored embeddings):

$$Similarity ( QE , {SE}_{j} ) = \frac{QE \cdot {SE}_{j}}{\vert QE \vert \vert {SE}_{j} \vert} .$$

Having identified a certain number of stored embeddings 360 having the highest Similarity (e.g., predetermined number K of best matches) search engine 138 may may use segment indexation 345 to retrieve the corresponding K stored segments. The retrieved segments 380 may be combined by prompt generator 140 (with reference to FIG. 1 and/or FIG. 2) with query 304 to form a prompt 390. Prompt 390 may then be provided for processing to LM 162. LM 162 may process prompt 390 and return a response 395 whose quality is improved by the presence of the retrieved segments 380.

FIG. 3B illustrates example operations 301 of parsing and segmentation performed as part of efficient RAG processing of FIG. 3A, according to at least one embodiment. Operations illustrated in FIG. 3B may be performed by parsing and segmentation module 134 operating on RAG server 130 (e.g., as shown in FIG. 1), client device 102, and/or other suitable computing device(s). Document 302 may include any suitable document content 320, including (but not limited to) text, drawings, pictures, plots, tables, fillable fields, footers, headers, reference lists, and/or other elements. Document 302 may have associated content metadata 330. Although shown as part of document 302, content metadata 330 may be in a separate file or index referencing document 302. A parsing engine (e.g., parsing engine 310, with reference to FIG. 3A) may identify document content 320 and content metadata 330. In some embodiments, content metadata may be stored in a separate metadata file for the document 302 and may be indexed to the content 320. The parsing engine may split document content 320 into content units 321, 322, 323, . . . 32N. Units may be defined as small fixed-size portions (e.g., 50 words/tokens, 100 words/tokens, etc.) of content 320 or portions that have natural boundaries, (e.g., paragraphs with defined paragraph breaks,) small sections, tables and/or table partitions, and/or other well-formed elements of the document. The size of content units 32X may be smaller than the size of eventual segments that are embedded by embedding model 136 (although in some instances single-unit segments may be formed if a unit is sufficiently distinct. The parsing engine may combine individual content units 32X into content groups 332 and may further add annotations 334 that is related to content of content units 32X, e.g., by selecting those portions of content metadata 330 that refer to respective content units 32X.

Combining content units 32X into individual content groups 332 may be performed based on similarity between units, e.g., in such a way that content units 32X within a particular content group 332 have more similarity than content units 32X from different groups. In one embodiment, similarity between units may be quantified using similarity scores determined based at least on content metadata for the individual content units 32X. For example, the parsing engine may define and track a number of metadata categories (which may be embodiment-specific), e.g., pyramid of sections/headings up to a certain maximum depth, tables/table elements (rows, columns, cells, etc.), belonging to a caption/header/footer, keywords, and/or the like. Individual content units 32X may be assigned values in one or more such categories. For example, a given content unit describing properties of electric fields may be assigned a first value Electric fields in association with the metadata category Section (e.g., as may be gathered from the <h1> HTML tag), a second value Static electric fields in association with metadata category Subsection (e.g., as may be gathered from the <h2> tag), a third value Static electric fields in different materials in association with metadata category Sub-Subsection (e.g., as may be gathered from the <h3> tag), and so on. Content units belonging to the table Electrical properties of intrinsic semiconductors may receive the corresponding value in association with the metadata category Table caption while content units belonging to the column Electrical resistance of intrinsic semiconductors of that table may additionally receive the respective value in association with the metadata category Table column, and so on. In those instances where a content unit does not have a value in relation to one or more categories, e.g., does not belong to a table, table element, caption, etc., or belongs to a portion of a document that does not have subsections/sub-subsections/etc., the corresponding categories can be given null (e.g., zero) values.

The values assigned to the metadata categories of two (or more) content units 32X may be used to determine a similarity score S₁ for those units. For example, if the units have the same Section value (indicating that the units belong to the same section), a certain similarity score S₁ may be assigned to the units. If the units also have the same Subsection value (indicating that the units belong to the same subsection), a further similarity score S₂ may be assigned to the units, and so/on. Likewise, additional similarity scores S₃, S₄, etc. may be assigned for having the common values in any other metadata categories, e.g., tables, captions, keywords, and/or the like.

Individual similarity scores may be aggregated (e.g., added) to obtain a total similarity score Sₜₒₜ=S₁+S₂+ . . . , which may be used to determine if two (or more) units have similar content and thus favor being represented by a single embedding 360 or a set of related embeddings 360. In one example embodiment, the total similarity score Sₜₒₜ exceeding an empirically set threshold value S_{T} (which may depend on a particular set of defined metadata categories and individual similarity scores Sₖ assigned to those categories) may indicate that the content units are sufficiently similar or related to be included (if practically possible) into the same content group 332. Conversely, the total similarity score Sₜₒₜ being less than the threshold value S_{T} indicates that the content units are sufficiently distinct to be included in different content groups 332.

Multiple content units 32X may be similarly evaluated for inclusion into various content groups 332. In one example embodiment, a set of multiple content units 32X may be included in the same content group 332 if similarity scores of pairs of adjacent candidate units are above S_{T}. When a new content unit has a similarity score below threshold value S_{T}, the current content group may be concluded, and the next content group may be commenced starting from the new content unit. In another embodiment, a new content unit is included in the current content group provided that pairwise similarity scores of the new candidate content unit with all content units (or with at least a certain minimum fraction of content units) already in the group are above S_{T}. The disclosed embodiments result in content groups 332 of variable size sharing a common linguistic and/or semantic context rather than context-agnostic groups of fixed size. Content groups 332 may be associated with annotations 334, which may include portions of content metadata 330 that characterizes content units 32X of the respective groups.

After the parsing engine identifies content groups 332 having common context, a segmentation engine (e.g., segmentation engine 340 in FIG. 3A) may partition content group 332 into segments for inputting into embedding model 136. In some embodiments, the partitioning may be based on overall size (e.g., length) of content group 332. In some embodiments, the size count may include both the content and the annotations 334.

In some embodiments, a whole content group 332 may be treated as one document segment and embedded, by embedding model 136, into a single embedding 360. As a result, the search engine implementing the retrieval of the documents from RAG store 370 may always retrieve the entire content group. In other embodiments, the segmentation engine may define a maximum size L₀ of a segment, so that when a content group's size exceeds L₀, the content group is split into multiple segments, e.g., segments 341 and 342. In some embodiments, segmentation of a large group may start, as a default, with a maximum-size segment independently of how much space is available in the previous segment. In some embodiments, a portion of the large group may be added to the previous segment if space is available therein. In some embodiments, segmentation of large groups may be optimized to reduce the number of segment splits. Following partitioning of a content group 332 into segments 341 and 342, annotations 334 may be added to the individual segments. In some embodiments, annotations 334 added to various units of the same group may be the same or at least share a common portion, to improve alignment of different embeddings 360 corresponding to the same content group.

In some embodiments, as shown schematically in FIG. 3B, annotations 334 may also be associated with generated embeddings 360 to form annotated embeddings 362. The search engine performing search of stored embeddings may additionally search annotations 334 (e.g., using keywords search or any suitable NLP techniques) for improved search accuracy. In some embodiments, embedding model 136 may process segments 341 and 342 without annotations 334 while adding annotations 334 to embeddings 360 as metadata to form annotated embeddings 362.

In some embodiments, a hybrid approach may be used where some (first) portion of annotations 334 is embedded with the segments while another (second) portion of annotations 334 is added as metadata to embeddings 360. In some embodiments, the first portion and the second portion may have some overlap.

FIG. 3C illustrates example operations 303 of language model captioning to assist in flexible content-based document segmentation of efficient RAG processing, according to at least one embodiment. As shown in FIG. 3C, a content group 332 (e.g., identified as disclosed in conjunction with FIG. 3B) may be processed by an annotation model 315 capable of annotating or captioning inputs. In some embodiments, annotation model 315 can include a trained language model. In some embodiments, annotation model 315 can be (or include) LM 162 (with reference to FIG. 3A). In other embodiments, annotation model 315 may be different from LM 162. Annotation model 315 may process content group 332 and generate a caption 336 that provides a short description for the content group 332, which may also be used as a common caption for segments (e.g., 341, 342, etc.) of the content group 332. The caption 336 may be embedded in embeddings 360, added as metadata for annotated embeddings 362 stored in embeddings store 374, or both. Caption 336 may be used by search engine 138 as part of caption processing, which may include filtering candidate segments (identified by the embeddings search portion of search engine 138) that are of little relevance to received queries. For example, search engine 138 may include an NLP component that compares captions 336 of candidate segments to the queries and discards those candidate segments that have little or no similarity with the query and outputs retrieved segments 380 that have at least a minimum similarity to the query.

In some embodiments, the retrieved segments 380 may be ranked in the order of the segments' similarity to the query. The ranking of the retrieved segments 380 may be generated via a combination of the embedding similarity (e.g., cosine similarity) between embedding(s) of the query and embeddings 360 of the segments and the linguistic similarity between captions 336 of the corresponding embedding and the language of the query. In some embodiments, the two types of similarities may be suitably weighted with empirically set weights, and the ranking of retrieved segments 380 may be performed using the combined (weighted) similarity.

FIG. 4 illustrates an example data flow 400 of efficient RAG processing that uses flexible content-based segmentation of documents lacking content metadata, according to at least one embodiment. As illustrated, a document 402 may have no explicitly identified headers, topics, tables, and/or other metadata representative of content distribution in document 402. For example, document 402 may be a plain text document, such as an OCR-generated document, and/or other similar document. In some embodiments, document 402 may be an image or a series of related images (e.g., video clip). Document 402 may be used as an input into an LM annotator 410, which may be (or include) a trained LM trained to add synthetic metadata 420 to document 402, e.g., HTML-type or other suitable metadata. LM annotator 410 may be the same or different from LM 162 (with reference to FIG. 3A) that is used to process user queries/prompts or annotator model 315 (with reference to FIG. 3C) that is used to add captions to parsed documents.

In some embodiments, document 402 may be an image or series of images, and LM annotator 140 may be a VLM or a MMLM. In such embodiments, document 402 may be processed by a VLM or a MMLM that identifies structure (distribution of content) of the document based on the visual appearance of document 402, or a combination of the visual appearance and text content of the document. The VLM (or MMLM) annotator may identify sections/headings, topics, tables partitions, figures, emphasized language, and/or other similar information representative of the content distribution in the document. In some embodiments, a VLM (or MMLM) may also identify locations of special objects, e.g., images, plots, graphics, etc., in the document and generate separate embeddings representative of such cropped special objects.

Document 402 with synthetic metadata 420 may be processed by parsing engine 310 that identifies content units 32X and content groups 332 and adds annotations 334 based on synthetic metadata 420 (e.g., substantially as disclosed in conjunction with FIG. 3A and FIG. 3B). In some embodiments, to reduce potential consequences of hallucinations during prompt processing, annotations 334 may be added to segments 421 and 422 for generation of embeddings 360 but not added to the stored document segments 421 and 422 (this scenario is depicted in FIG. 4). In other embodiments, annotations 334 may also be added to stored document segments and may further be added to the queries to form prompts to the language model.

FIGS. 5 and 6 illustrate example methods 500 and 600 directed to efficient RAG processing that uses flexible content-based document segmentation. Methods 500 and 600 may be used in the context of deployment and/or use of AI, including (but not limited) to the deployment and/or use of language models, vision language models, multi-modal language models, computer vision models, text-to-speech models, speech-to-text models, and/or other AI models where processing of an input into an AI model (e.g., text, image, speech, audio, video, digital assets, CAD, and/or any other data) may be improved by augmenting the input with an appropriate contextual information (e.g., instances of historical data, background data, sample data, and/or the like). In at least one embodiment, methods 500 and/or 600 may be performed using one or more processing units of client device 102 and/or RAG server 130 of FIG. 1, computing device 200 of FIG. 2, and/or some other computing device or a combination of computing devices. The one or more processing units (e.g., CPUs, GPUs, accelerators, PPUs, DPUs, etc.) performing methods 500 and/or 600 may include (or communicate with) one or more memory devices.

In at least one embodiment, methods 500 and/or 600 may be performed by the same computing device. In at least one embodiment, methods 500 and/or 600 may be performed by different computing devices. In at least one embodiment, processing units performing methods 500 and/or 600 may be executing instructions stored on non-transient computer-readable storage media. In at least one embodiment, methods 500 and/or 600 may be performed using multiple processing threads (e.g., CPU threads and/or GPU threads), with individual threads executing one or more individual functions, routines, subroutines, or operations of the methods. In at least one embodiment, processing threads implementing any of methods 500 and/or 600 may be synchronized (e.g., using semaphores, critical sections, and/or other thread synchronization mechanisms). Alternatively, processing threads implementing any of methods 500 and/or 600 may be executed asynchronously with respect to each other. Various operations of any of methods 500 and/or 600 may be performed in a different order compared with the order shown in FIGS. 5 and 6. Some operations of any of methods 500 and/or 600 may be performed concurrently with other operations. In at least one embodiment, one or more operations shown in FIGS. 5 and 6 may not always be performed.

FIG. 5 is a flow diagram of an example method 500 of an indexing stage of efficient RAG processing that uses flexible content-based document segmentation, according to at least one embodiment. At block 510, method 500 may include obtaining, using a processing device, content metadata representative of a distribution of content of a document (e.g., document 302 in FIGS. 3A-3B). The document may include a text document, an image, an audio file, a video file, a data file, and/or the like. The content of the document may include text, one or more audios, one or more images, including videos or other sets of contextually connected images, and/or any combination thereof. The content metadata may include (but need not be limited to) one or more hierarchical levels of headings, one or more keywords, one or more table elements, one or more table captions, one or more image captions, one or more video captions, one or more captions of page partitions, one or more paragraph delimiters, and/or any combination thereof. In some embodiments, image and/or video captions can be generated by a VLM, MMLM, or other AI models, and can include closed captions.

In some embodiments, e.g., where the document is unstructured, e.g., lacks intrinsic metadata, obtaining the content metadata may include operations of the top callout block 512 of FIG. 5, which includes processing, using a language model (e.g., annotation model 315 in FIG. 3C), a prompt that includes one or more portions of the document and a request to the LM to generate the content metadata. In such embodiments, LM may be (or include) a large language model, a small language model, a vision language model, a multi-modal language model, and/or some combination thereof.

At block 520, method 500 may include segmenting, using the content metadata, the document into a plurality of segments. At least two segments of the plurality of segments may have different sizes. In some embodiments, segmenting the document into the plurality of segments may include operations of the middle callout block 522 of FIG. 5, which includes representing a group of units of the document characterized by a similarity above a threshold similarity (e.g., content group 332 in FIG. 3B) via one or more segments of the plurality of segments (e.g., segments 341, 342 in FIG. 3B). In some instances, a combined size of the group of units may be less than a predetermined size. In such instances, the group of units may be represented by a single segment of the plurality of segments. At block 530, method 500 may continue with adding at least a portion of the content metadata to the individual segment (e.g., adding annotations 334 to segments 341, 342 of the same content group).

At block 540, method 500 may include processing, using an embedding model (e.g., embedding model 136 in FIG. 3A), the plurality of segments to generate a plurality of embeddings (e.g., embeddings 360). In some embodiments, processing the plurality of segments may include operations illustrated with the bottom callout portion of FIG. 5. More specifically, at block 542, method 500 may include processing, using the embedding model, one or more unannotated segments to generate one or more embeddings. At block 544, operations of method 500 may continue with annotating each embedding of the one or more embeddings with at least a portion of the content metadata common to individual units of the group of units. For example, content annotations 334 may be added to segments 341, 342 before generating embeddings 360 (with reference to FIG. 3B), after generating embeddings 360, or both.

At block 550, method 500 may include storing the plurality of embeddings in a data store and, at block 560, include storing the plurality of segments in the data store (e.g., RAG store 370 with reference to FIG. 3A) in association with indexation data (e.g., segment indexation 345) that maps the plurality of embeddings to the plurality of segments.

FIG. 6 is a flow diagram of an example method 600 of a query processing stage of efficient RAG processing that uses flexible content-based document segmentation, according to at least one embodiment. At block 610, method 600 may include receiving a query (e.g., query 304 in FIG. 3A). The query may include a text, one or more images, tables, data sets, audio files, video files, and/or the like, or any combination thereof. At block 620, method 600 may include causing an embedding model to process the query to generate one or more query embeddings (e.g., query embeddings 306 in FIG. 3A).

At block 630, method 600 may continue with computing a plurality of similarity scores characterizing similarity of the one or more query embeddings to a plurality of (stored) embeddings associated with one or more stored documents. At block 640, method 600 may continue with selecting, using the plurality of similarity scores, one or more segments of the one or more stored documents (e.g., retrieved segments 380 in FIG. 3A). The one or more selected segments may be from a single stored document or from multiple stored documents. The number of segments selected from a given document need not be limited. In some embodiments, selecting the one or more segments may include accessing stored indexation data (e.g., segment indexation 345 in FIG. 1) that maps the plurality of (stored) embeddings (e.g., embeddings 360) to the one or more stored segments (e.g., annotated segments 350).

In some embodiments, selecting the one or more segments may include one or more operations illustrated in the top callout portion of FIG. 6. For example, at block 642, operations of method 600 may include identifying, using the plurality of similarity scores, a plurality of candidate segments potentially associated with the query. At block 644, operations of method 600 may further include filtering out (e.g., eliminating as irrelevant, or insufficiently relevant, to the query) one or more candidate segments based on the content metadata stored in association with the embeddings.

In some embodiments, as illustrated with the bottom callout block 646 in FIG. 6, selecting the one or more segments may include ranking the candidate segments using the content metadata (annotations, captions, etc.) stored in association with the embeddings and providing the rankings to the LM (e.g., together with the prompt). In some embodiments, some of the candidate segments may be eliminated based on the rankings while the rankings of the remaining candidate segments may be provided to the LM together with the candidate segments.

At block 650, method 600 may include generating an LM prompt and processing the LM prompt using an LM to obtain a response to the query. The LM prompt may be based at least on the query and the one or more selected segments, e.g., segments identified using the embedding search, content metadata/annotation search, rankings, and/or the like. After processing the generated LM prompt, the LM may return a response, which may be provided to the user (e.g., via RAG API 106 and UI 104, with reference to FIG. 1).

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, analytics operations, factory operations, generation and/or presentation of augmented reality (AR), virtual reality (VR), mixed reality (MR), etc., robotics operations, medical operations, security and surveillance (e.g., in a smart cities embodiment), autonomous or semi-autonomous machine applications, deep learning, environment simulation, object or actor simulation and/or digital twinning, data center processing, generative AI operations, conversational AI operations, operations involving vision language models, large language models, small language models, multi-modal language models, light transport simulations (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), and in-vehicle infotainment system for an autonomous or semi-autonomous machine, systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Inference and Training Logic

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating-point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model, or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., architecture 1000 of FIG. 10). In at least one embodiment, once validated by architecture 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., architecture 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example architecture 1000 for generating and deploying a deployment pipeline, according to at least one embodiment. In at least one embodiment, architecture 1000 may be used to implement process 900 of FIG. 9 and/or other processes including advanced processing and inferencing pipelines. In at least one embodiment, architecture 1000 may include training system 904 and deployment system 906. In at least one embodiment, training system 904 and deployment system 906 may be implemented using software 918, services 920, and/or hardware 922, as described herein.

In at least one embodiment, architecture 1000 (e.g., training system 904 and/or deployment system 906) may implemented in a cloud computing environment (e.g., using cloud 1026). In at least one embodiment, architecture 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of architecture 1000, may be restricted to a set of public internet service providers (ISPs) that have been vetted or authorized for interaction.

In at least one embodiment, various components of architecture 1000 may communicate between and among one another using any of a variety of different network types, including but not limited to local area networks (LANs) and/or wide area networks (WANs) via wired and/or wireless communication protocols. In at least one embodiment, communication between facilities and components of architecture 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904, and may be implemented by deployment system 906.

In at least one embodiment, output model(s) 916 and/or pre-trained model(s) 1006 may include any types of machine learning models depending on embodiment. In at least one embodiment, and without limitation, machine learning models used by architecture 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, architecture 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and interact with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904. In at least one embodiment, training system 904 and deployment system 906 may include DICOM adapters 1002A and 1002B.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within architecture 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA® and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of architecture 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of architecture 1000.

In at least one embodiment, cloud 1026 may include a GPU-accelerated infrastructure (e.g., NVIDIA's NGC™) that may provide a GPU-optimized platform for executing processing tasks of architecture 1000. In at least one embodiment, cloud 1026 may include an AI system(s) 1024 for performing one or more of AI-based tasks of architecture 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of architecture 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for architecture 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### Example Language Models

In at least some embodiments, language models, such as large language models (LLMs) and/or other types of generative artificial intelligence (AI) may be implemented. These models may be capable of understanding, summarizing, translating, and/or otherwise generating text (e.g., natural language text, code, etc.), images, video, computer aided design (CAD) assets, omniverse and/or metaverse file information (e.g., in USD format), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/etc. may be implemented for summarizing textual data, analyzing and extracting insights from data (e.g., textual, image, video, etc.), and generating new text/image/video/etc. in user-specified styles, tones, or formats. The LLMs of the present disclosure may be used exclusively for text processing, in embodiments, whereas in other embodiments, multimodal LLMs may be implemented to accept, understand, and/or generate text along with other types of content like images, audio, and/or video. For example, vision language models (VLMs), or more generally multimodal language models, may be implemented to accept image, video, audio, textual, 3D design (e.g., CAD), and/or other inputs data types and/or to generate or output image, video, audio, textual, 3D design, and/or other output data types.

Various types of LLM/VLM/etc. architectures may be implemented in various embodiments. For example, different architectures may be implemented that use different techniques for understanding and generating outputs—such as text, audio, video, image, etc. In some embodiments, LLM architectures such as recurrent neural networks (RNNs) or long short-term memory networks (LSTMs) may be used, while in other embodiments transformer architectures—such as those that rely on self-attention mechanisms—may be used to understand and recognize relationships between words or tokens. The language models of the present disclosure may include encoder and/or decoder block(s). For example, discriminative or encoder-only LLMs like BERT (Bidirectional Encoder Representations from Transformers) may be implemented for tasks that involve language comprehension such as classification, sentiment analysis, question answering, and named entity recognition. As another example, generative or decoder-only LLMs like GPT (Generative Pretrained Transformer) may be implemented for tasks that involve language and content generation such as text completion, story generation, and dialogue generation. LLMs that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the model(s).

In various embodiments, the LLMs/VLMs/etc. may be trained using unsupervised learning, in which an LLM learns patterns from large amounts of unlabeled text/audio/video/image/etc. data. Due to the extensive training, in embodiments, the models may not require task-specific or domain-specific training. LLMs that have undergone extensive pre-training on vast amounts of unlabeled text data may be referred to as foundation models and may be adept at a variety of tasks like question-answering, summarization, filling in missing information, and translation. Some LLMs may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/etc. of the present disclosure may be implemented using various model alignment techniques. For example, in some embodiments, guardrails may be implemented to identify improper or undesired inputs (e.g., prompts) and/or outputs of the models. In some non-limiting embodiments, the guardrails implemented may be similar to those described in U.S. Pat. App. No. 18,304,341, filed on Apr. 20, 2023, the contents of which are hereby incorporated by reference in their entirety. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/embodiment. As a result, the LLMs/VLMs/etc. of the present disclosure may be less likely to output language/text/audio/etc. that may be offensive, vulgar, improper, unsafe, out of domain, and/or otherwise undesired for the particular application/embodiment.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

FIG. 11A is a block diagram of an example generative language model system 1100 suitable for use in implementing at least some embodiments of the present disclosure. In the example illustrated in FIG. 11A, the generative language model system 1100 includes a retrieval augmented generation (RAG) component 1192, an input processor 1105, a tokenizer 1110, an embedding component 1120, plug-ins/APIs 1195, and a generative language model (LM) 1130 (which may include an LLM, a SLM, a VLM, a multi-modal LM, etc.).

At a high level, the input processor 1105 may receive an input 1101 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1130 (e.g., LLM/SLM/VLM/MMLM/etc.). In some embodiments, the input 1101 includes plain text in the form of one or more sentences, paragraphs, and/or documents. Additionally or alternatively, the input 1101 may include numerical sequences, precomputed embeddings (e.g., word or sentence embeddings), and/or structured data (e.g., in tabular formats, JSON, or XML). In some embodiments in which the generative LM 1130 is capable of processing multi-modal inputs, the input 1101 may combine text (or may omit text) with image data, audio data, video data, design data, USD data, and/or other types of input data, such as but not limited to those described herein. Taking raw input text as an example, the input processor 1105 may prepare raw input text in various ways. For example, the input processor 1105 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1105 may remove stopwords to reduce noise and focus the generative LM 1130 on more meaningful content. The input processor 1105 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1192 (which may include one or more RAG models, and/or may be performed using the generative LM 1130 itself) may be used to retrieve additional information to be used as part of the input 1101 or prompt. RAG may be used to enhance the input to the LLM/SLM/VLM/MMLM/etc. with external knowledge, so that answers to specific questions or queries or requests are more relevant—such as in a case where specific knowledge is required. The RAG component 1192 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 1101 may be generated using the query or input to the model (e.g., a question, a request, etc.) in addition to data retrieved using the RAG component 1192. In some embodiments, the input processor 1105 may analyze the input 1101 and communicate with the RAG component 1192 (or the RAG component 1192 may be part of the input processor 1105, in embodiments) in order to identify relevant text and/or other data to provide to the generative LM 1130 as additional context or sources of information from which to identify the response, answer, or output 1190, generally. For example, where the input indicates that the user is interested in a desired tire pressure for a particular make and model of vehicle, the RAG component 1192 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1192 may retrieve a prior stored conversation history—or at least a summary thereof—and include the prior conversation history along with the current ask/request as part of the input 1101 to the generative LM 1130.

The RAG component 1192 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1192 and the embeddings of the chunks along with the embeddings of the query may be compared to identify the most similar/related embeddings to the query, which may be supplied to the generative LM 1130 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1192 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1110 may segment the (e.g., processed) text data into smaller units (tokens) for subsequent analysis and processing. The tokens may represent individual words, subwords, characters, portions of audio/video/image/etc., depending on the embodiment. Word-based tokenization divides the text into individual words, treating each word as a separate token. Subword tokenization breaks down words into smaller meaningful units (e.g., prefixes, suffixes, stems), enabling the generative LM 1130 to understand morphological variations and handle out-of-vocabulary words more effectively. Character-based tokenization represents each character as a separate token, enabling the generative LM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format according to tokenization schema being implemented in the particular embodiment.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some embodiments in which the input 1101 includes image data/video data/etc., the input processor 1101 may resize the data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some embodiments in which the input 1101 includes audio data, the input processor 1101 may resample an audio file to a consistent sampling rate for uniform processing, and the embedding component 1120 may use any known technique to extract and encode audio features-such as in the form of a spectrogram (e.g., a mel-spectrogram). In some embodiments in which the input 1101 includes video data, the input processor 1101 may extract frames or apply resizing to extracted frames, and the embedding component 1120 may extract features such as optical flow embeddings or video embeddings and/or may encode temporal information or sequences of frames. In some embodiments in which the input 1101 includes multi-modal data, the embedding component 1120 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1130 and/or other components of the generative LM system 1100 may use different types of neural network architectures depending on the embodiment. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the embodiment and architecture, the embedding component 1120 may apply an encoded representation of the input 1101 to the generative LM 1130, and the generative LM 1130 may process the encoded representation of the input 1101 to generate an output 1190, which may include responsive text and/or other types of data.

As described herein, in some embodiments, the generative LM 1130 may be configured to access or use—or capable of accessing or using—plug-ins/APIs 1195 (which may include one or more plug-ins, application programming interfaces (APIs), databases, data stores, repositories, etc.). For example, for certain tasks or operations that the generative LM 1130 is not ideally suited for, the model may have instructions (e.g., as a result of training, and/or based on instructions in a given prompt, such as those retrieved using the RAG component 1192) to access one or more plug-ins/APIs 1195 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1195 to the plug-in/API 1195, the plug-in/API 1195 may process the information and return an answer to the generative LM 1130, and the generative LM 1130 may use the response to generate the output 1190. This process may be repeated—e.g., recursively—for any number of iterations and using any number of plug-ins/APIs 1195 until an output 1190 that addresses each ask/question/request/process/operation/etc. from the input 1101 can be generated. As such, the model(s) may not only rely on its own knowledge from training on a large dataset(s) and/or from data retrieved using the RAG component 1192, but also on the expertise or optimized nature of one or more external resources-such as the plug-ins/APIs 1195.

FIG. 11B is a block diagram of an example embodiment in which the generative LM 1130 includes a transformer encoder-decoder suitable for use in implementing at least some embodiments of the present disclosure. For example, assume input text such as “Who discovered gravity” is tokenized (e.g., by the tokenizer 1110 of FIG. 11A) into tokens such as words, and each token is encoded (e.g., by the embedding component 1120 of FIG. 911A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1135 of the generative LM 1130.

In an example embodiment, the encoder(s) 1135 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1140 may convert the context vector into attention vectors (keys and values) for the decoder(s) 1145.

In an example embodiment, the decoder(s) 1145 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1135, in an example transformer architecture, each token (e.g., word) flows through a separate path in the decoder(s) 1145. During a first pass, the decoder(s) 1145, a classifier 1150, and a generation mechanism 1155 may generate a first token, and the generation mechanism 1155 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1145 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example embodiment, the encoder-decoder attention layer operates similarly to the (e.g., multi-headed) self-attention in the encoder(s) 1135, except that it creates its queries from the layer below it and takes the keys and values (e.g., matrix) from the output of the encoder(s) 1135.

As such, the decoder(s) 1145 may output some decoded (e.g., vector) representation of the input being applied during a particular pass. The classifier 1150 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1155 may select or sample a word or token based on a corresponding predicted probability (e.g., select the word with the highest predicted probability) and append it to the output from a previous pass, generating each word or token sequentially. The generation mechanism 1155 may repeat the process, triggering successive decoder inputs and corresponding predictions until selecting or sampling a symbol or token that represents the end of the response, at which point, the generation mechanism 1155 may output the generated response.

FIG. 11C is a block diagram of an example embodiment in which the generative LM 1130 includes a decoder-only transformer architecture suitable for use in implementing at least some embodiments of the present disclosure. For example, the decoder(s) 1160 of FIG. 11C may operate similarly as the decoder(s) 1145 of FIG. 11B except each of the decoder(s) 1160 of FIG. 11C omits the encoder-decoder self-attention layer (since there is no encoder in this embodiment). As such, the decoder(s) 1160 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1160. As with the decoder(s) 1145 of FIG. 11B, each token (e.g., word) may flow through a separate path in the decoder(s) 1160, and the decoder(s) 1160, a classifier 1165, and a generation mechanism 1170 may use auto-regression to sequentially generate one token at a time until predicting a symbol or token that represents the end of the response. The classifier 1165 and the generation mechanism 1170 may operate similarly as the classifier 1150 and the generation mechanism 1155 of FIG. 11B, with the generation mechanism 1170 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). As such, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs), one or more decoupled accelerators (e.g., decoupled lookup table (DLUT) accelerators), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that allow the computing device 1200 to communicate with other computing devices via an electronic communication network, included wired and/or wireless communications. The communication interface 1210 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may allow the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that allow detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to allow the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may use distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
obtaining, using a processing device, content metadata representative of a distribution of content of a document;
assigning, by a processing device, each of a plurality of units of the document one or more metadata values characterizing association of a respective unit with one or more metadata categories of the content metadata;
segmenting, by the processing device, the document into a plurality of segments, wherein each segment of at least a subset of the plurality of segments is obtained by grouping multiple units of the plurality of units of the document, the multiple units characterized by a similarity score above a threshold score, the similarity score computed based on aggregation of similarity values determined from the one or more metadata values assigned to the multiple units;
processing, by the processing device executing an embedding model, the plurality of segments to generate a plurality of embeddings, wherein each embedding of the plurality of embeddings is associated with a point in a multi-dimensional embedding space, wherein a number of dimensions of the multi-dimensional embedding space is determined by an architecture of the embedding model, and wherein the embedding model is trained to associate input text strings with points in the multi-dimensional embedding space having a degree of separation that is based on similarity of the input text strings; and
storing, by the processing device, the plurality of embeddings in a data store.

2. The method of claim 1, wherein the content of the document comprises at least one of:
a text,
one or more audios, or
one or more images.

3. The method of claim 1, wherein the content metadata comprises one or more of:
one or more hierarchical levels of headings,
one or more table elements,
one or more keywords,
one or more table captions,
one or more image captions,
one or more video captions,
one or more captions of page partitions, or
one or more paragraph delimiters.

4. The method of claim 1, wherein the content metadata comprises:
two or more hierarchical levels of headings.

5. The method of claim 1, further comprising:
adding, prior to the embedding model processing an individual segment of the plurality of segments, at least a portion of the content metadata to the individual segment.

6. The method of claim 1, further comprising:
storing the plurality of segments in the data store in association with indexation data that maps the plurality of embeddings to the plurality of segments.

7. (canceled)

8. The method of claim 1, wherein processing the plurality of segments comprises:
processing, using the embedding model, one or more segments of the plurality of segments to generate one or more embeddings of the plurality of embeddings; and
annotating each embedding of the one or more embeddings with at least a portion of the content metadata common to individual units of the multiple units.

9. The method of claim 1, wherein a combined size of the group of units is less than a predetermined size, and wherein the multiple units are represented by a single segment of the plurality of segments.

10. The method of claim 1, wherein obtaining the content metadata comprises:
processing, using a language model (LM), a prompt to generate the content metadata, wherein the prompt comprises:
one or more portions of the document, and
a request to the LM to generate the content metadata.

11. The method of claim 10, wherein the LM is at least one of:
a large language model,
a small language model,
a vision language model, or
a multi-modal language model.

12. The method of claim 1, further comprising:
storing, in the data store, an individual segment of the plurality of segments;
processing the individual segment together with a portion of the content metadata added to the individual segment to generate the one or more embeddings; and
storing, in the data store, indexation data associating the stored individual segment with the one or more embeddings.

13. The method of claim 1, further comprising:
causing the embedding model to process a query to generate one or more query embeddings;
computing a plurality of embedding similarity scores characterizing similarity of the one or more query embeddings to the plurality of embeddings;
selecting, using the plurality of embedding similarity scores, one or more segments of the plurality of segments; and
causing a prompt, generated based at least on the query and the one or more selected segments, to be processed by a language model to obtain a response to the query.

14. A system comprising:
one or more processors to:
obtain content metadata representative of a distribution of content of a document;
assign each of a plurality of units of the document one or more metadata values characterizing association of a respective unit with one or more metadata categories of the content metadata;
segment the document into a plurality of variable-length segments, wherein each segment of at least a subset of the plurality of segments is obtained by grouping multiple units of the plurality of units of the document, the multiple units characterized by a similarity score above a threshold score, the similarity score computed based on aggregation of similarity values determined from the one or more metadata values assigned to the multiple units;
process, using an embedding model, the plurality of variable-length segments to generate a plurality of embeddings, wherein each embedding of the plurality of embeddings is associated with a point in a multi-dimensional embedding space, wherein a number of dimensions of the multi-dimensional embedding space is determined by an architecture of the embedding model, and wherein the embedding model is trained to associate input text strings with points in the multi-dimensional embedding space having a degree of separation that is based on similarity of the input text strings; and
retrieve relevant document segments using at least the plurality of embeddings.

15. The system of claim 14, wherein the content metadata comprises one or more of:
one or more hierarchical levels of headings,
one or more keywords,
one or more table elements,
one or more table captions,
one or more image captions,
one or more video captions,
one or more captions of page partitions, or
one or more paragraph delimiters.

16. The system of claim 14, wherein the one or more processors are further to:
add, prior to the embedding model processing an individual segment of the plurality of variable-length segments, at least a portion of the content metadata to the individual segment.

17. The system of claim 14,
wherein to process the plurality of variable-length segments, the one or more processors are to:
process, using the embedding model, the one or more segments to generate one or more embeddings; and
annotate each embedding of the one or more embeddings with at least a portion of the content metadata common to individual units of the group of units.

18. The system of claim 14, wherein to obtain the content metadata, the one or more processors are to:
process, using a language model (LM), a prompt to generate the content metadata, wherein the prompt comprises:
one or more portions of the document, and
a request to the LM to generate the content metadata.

19. The system of claim 14, wherein the system is comprised in at least one of:
an in-vehicle infotainment system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system for generating or presenting at least one of virtual reality content, mixed reality content, or augmented reality content;
a system implemented using a robot;
a system for performing one or more conversational AI operations;
a system implementing one or more language models;
a system implementing one or more large language models (LLMs);
a system implementing one or more small language models (SLMs);
a system implementing one or more vision language models (VLMs);
a system implementing one or more multi-modal language models;
a system for performing one or more generative AI operations;
a system for generating synthetic data;
a system incorporating one or more virtual machines (VMs);
a system implemented at least partially in a data center; or
a system implemented at least partially using cloud computing resources.

20. One or more processors comprising:
processing circuitry to generate a database of documents, an individual document of the database represented by one or more embeddings generated by an embedding model processing one or more segments of the document, wherein each embedding of the one or more embeddings is associated with a point in a multi-dimensional embedding space, wherein a number of dimensions of the multi-dimensional embedding space is determined by an architecture of the embedding model, and wherein the embedding model is trained to associate input text strings with points in the multi-dimensional embedding space having a degree of separation that is based on similarity of the input text strings, wherein at least a subset of the one or more segments includes an aggregation of multiple units of the document grouped based on aggregated similarity scores for the respective multiple units, each aggregated similarity score computed based on metadata values assigned to individual units of the multiple units and associated with document metadata representative of a semantic distribution of content of the document.

21. (canceled)
